(19) United States
(12) Patent Application Publication
(10) Pub. No.: US 2014/0174638 A1
(43) Pub. Date: Jun. 26, 2014

(54) THREAD DISPLACEMENT DEVICE

(71) Applicant: SSM Schärer Schweiter Mettler AG, Horgen (CH)

(72) Inventors: André Wandeler, Samstagern (CH); Davide Maccabruni, Thalwil (CH); Christian Muser, Samstagern (CH)

(73) Assignee: SSM Scharer Schweiter Mettler AG, Horgen (CH)

(21) Appl. No.: 14/192,206

(22) Filed: Feb. 27, 2014

Related U.S. Application Data
(63) Continuation of application No. PCT/EP2012/066681, filed on Aug. 28, 2012.

(30) Foreign Application Priority Data
Aug. 31, 2011 (EP) 11179547.2

(51) Int. Cl. B65H 57/00; B29D 30/14

(52) U.S. Cl. CPC B65H 57/00; B29D 30/14
USPC 156/117; 242/476.7

(57) ABSTRACT

A thread displacement device for displacing a thread on a winding body includes a thread guide, which, depending on a movement of the winding body, can be freely selectively moved back and forth along a curved path defined by guide means. The thread guide has a thread guide roller rotatably mounted about a thread guide roller rotational axis to guide and press the thread against the winding body, said thread guide roller being configured as a self-directing roller. The guide means includes a flexibly deformable traction means, which can be guided back and forth via deflection rollers and/or deflection rods and on which the thread guide is directly fastened.

### CROSS-REFERENCE TO RELATED APPLICATIONS

This continuation application claims priority to PCT/EP2012/066681 filed on Aug. 28, 2012 and published as WO 2013/030192 A2, which also claimed priority to the European application number 11179547.2 filed on Aug. 31, 2011, the contents of which are fully incorporated herein with these references.

### DESCRIPTION

1. Field of the Invention

The present invention relates to a thread displacement device for displacing a thread on a winding body.

2. Background of the Invention

When manufacturing structural components, fiber-reinforced composite materials are increasingly used because of their high specific rigidities and strengths. A manufacturing method frequently being used, in this case, is the so-called fiber-winding method, in which continuous threads are displaced tautly and generally lying close to one another by means of a thread guide, which, with respect to the winding body, is movably arranged on a winding body being used as the prototype, in order to form a semi-finished fiber product with defined shaping. The threads or fibers are generally arranged lying one above the other in a plurality of layers, predetermined fiber course directions of the individual layers being oriented, in each case, with regard to load axes of the later component. For example, tire carcasses have layers of this type.

The threads used during the fiber-winding method are embedded in a special plastics material matrix, in which the fibers are bound by cohesive and adhesive forces to the plastics material matrix. The threads may be impregnated in this regard with a corresponding thermoplastic or thermosetting plastics material (so-called prepregs), or the completed semi-finished fiber product is saturated with a liquid plastics material provided to form the plastics material matrix. The plastics material is cured to form the matrix in a separate manufacturing step. The winding body is used again or is broken up or remains as a dead mold in the later component.

A thread displacement device with a bi-directionally working thread guide which, at the thread outlet of its thread guide head, has two thread guide rollers with rigid rotational axes arranged in parallel and rigidly with respect to one another, is shown in EP 1 792 751 A2. The thread is guided through between the two thread guide rollers provided to guide and press the thread against a winding body. The thread guide head is tiltably mounted about a tilting axis, which is arranged orthogonally with respect to the longitudinal axis of the thread guide, on a holding part of the thread guide, so, depending on an adjustment movement of the thread guide, i.e. its respective movement direction, relative to the winding body only one of the thread guide rollers can be brought into contact with the winding body in each case. A motor drive is used to tilt the thread guide head. The thread is in each case firmly pressed against the winding body by the thread guide roller resting on the winding body. A thread guide of this type has a complex and elaborate mechanical structure and is difficult to control. Moreover, the danger exists in displacement patterns of the thread on the winding body, in which the winding body is rotated past at higher peripheral speeds under the thread guide, that the thread will be released from its guidance on the respective guide roller by the winding body. The thread guide, due to its construction, also has a large number of supporting components for the thread feed, which leads to an undesired speed-limiting inertia of the thread guide.

U.S. Pat. No. 5,518,564 shows a thread displacement device with a thread guide, which has a thread guide roller for guiding and pressing the thread against the winding body. The thread guide roller is rotatably mounted about a thread guide roller rotational axis and is configured as a self-directing roller. By means of a complex multi-axis linear guide system, the thread guide can be moved back and forth, depending on a movement of the winding body, along a defined curved path relative to the winding body. The movement control of the thread guide is elaborate because of the movements of the thread guide, which are mounted one above the other in a multi-axial manner. Moreover, the thread displacement device is less suitable for displacing threads on more complex three-dimensional winding bodies. The thread displacement device is also not very suitable for high output rates, as are necessary, in particular in the mass production of fiber-reinforced structural components.

Further thread displacement devices of this type with a thread guide have become known from U.S. Pat. No. 4,772,352, U.S. Pat. No. 4,909,880 and U.S. Patent Publication 2007/079921 A1.

The object of the present invention is to disclose a thread guide and a thread displacement device, which avoid the drawbacks of the prior art. The object relating to the thread guide is achieved according to the invention by a thread displacement device having the features disclosed in claim 1. Further developments of the invention are the subject matter of the sub-claims.

### SUMMARY OF THE INVENTION

The advantage connected with the thread displacement device according to the invention is substantially that threads can be displaced in a simple and structurally less elaborate manner even on winding bodies with a complex three-dimensional geometry in order to thus manufacture a composite component. The curved path can thereby be freely defined within broad ranges in that the guide means comprise a flexibly deformable traction means that can be moved back and forth via deflection rollers or deflection rods, so a high degree of flexibility of use as regards the device is achieved. The device may, in this case, be converted without significant structural or financial outlay to the respective requirements, i.e. the geometry and the dimension of a winding body to be covered by a thread. This also provides decisive advantages in the individual or small-batch manufacturing of fiber-reinforced components. A thread course direction oriented on the construction side to later load lines of the composite component to be manufactured can be realized within broad ranges in a precise manner. In this case, established manufacturing techniques with dead or reusable molds, i.e. winding bodies, can be retained. As, according to the invention, the thread guide is directly fixed (fastened) to the traction means and is moved back and forth together therewith (on the same curved path), i.e. carries out a so-called traversing movement together therewith, the traction means preferably has as small a mass as possible in order to take into account high accelerations and decelerations of the thread guide along the curved path that occur during operation of the device. The flexible traction means may, for example, be configured as a cable, flexible tube, band, belt or else as a cord and manufactured with regard to the longest service life possible of the thread displacement device from a material which is highly resistant with respect to mechanical and chemical loads occurring during operation, in particular a steel alloy or else carbon fibers. Traction means of this type are commercially available prefabricated and are correspondingly economical to acquire. Moreover, the device allows, not least because of its simple mechanics, high output rates, and this is favorable, in particular for mass production of semi-finished fiber products for fiber-reinforced components. This is advantageous, in particular, in the production of supporting frameworks (carcasses) of rubber tires. Likewise, three-dimensional winding bodies, such as tires or pressure containers, can be reinforced. The most varied thread types can also be displaced on a winding body using the device. Apart from the carbon, aramid and/or glass fiber threads of interest for the mechanical reinforcement of components, threads made of materials with other specific properties, in particular flame-retardant or electrically conductive polymers, can also be used. The thread guide has a thread guide roller rotatably mounted about a thread guide roller rotational axis to guide and press the thread against the winding body, said thread guide roller being configured according to the invention as a self-directing roller. As a result, a thread guide with a structurally particularly simple structure, which is robust with respect to malfunctions, is provided. The individual thread guide roller of the thread guide ensures, even at a high peripheral speed (rotational speed) of the winding body, a reliable and precise displacement of the thread, as the thread guide roller is always automatically oriented along a predetermined displacement path of the thread on the winding body. The higher, for example, a peripheral speed of the winding body relative to the thread guide, the more strongly the self-directing roller can be deflected about its rotational axis. The thread can thus always be reliably guided on the guide roller without there being a danger of said thread being released (jumping down) from the thread guide roller. The thread guide roller can be provided on its lateral surface, in this case, in particular with a peripheral notch or groove to receive the thread. The notch or groove preferably has a notch depth oriented onto the thread to be displaced of about 50% of the thread thickness. Moreover, the thread guide according to the invention requires no complex control or drive technology as an adjustment movement of the thread guide roller configured as a self-directing roller can be derived purely from a relative movement of the winding body and the thread guide. Actuators for adjusting the thread guide roller are not required. Overall, the weight of the thread guide can also be thereby reduced, which is advantageous for high accelerations of the thread guide during operation.

In the structurally simplest case, the thread guide roller is arranged on a thread guide head, which is rotatably arranged about a rotational axis on a holding part of the thread guide. The thread guide roller rotational axis of the thread guide roller is, in this case, arranged spaced apart from the rotational axis of the thread guide head. The axes do not intersect.

The thread guide head can preferably be loaded with a torque acting about its rotational axis so that the thread can also be deposited precisely on the winding body in the region of the reversal points of the thread guide, which are particularly critical in practice, along the curved path. Thus, the instant of self-orientation of the thread guide roller, i.e. its pivoting movement about the pivot axis, can be initiated, i.e. provoked, precisely at a respective reversal point. A thread guide roller which is at first still oriented opposing the new movement direction and in which the thread would possibly not be guided on the thread guide roller and pressed thereby on the winding body, can thus be reliably avoided.

The torque can be generated according to the invention pneumatically or, for example, by the force of a spring element pre-stressed, for example, between the holding part and the thread guide head, or else by a motor.

When displacing a thread on the winding body, the thread, in particular in regions of a reversal of the thread course direction, such as, for example, in the edge regions of a semi-finished fiber product to be manufactured, or else in the region of concave surface portions of the winding body, has to be pressed against the winding body as far as possible with a defined pressure, so that the thread, once positioned, retains its position on the winding body. In this regard, it has proven to be advantageous for the thread guide head to be (additionally) resiliently displaceably mounted with respect to the holding part of the thread guide.

The thread guide is configured as a hollow body (tubular) and therefore light in weight. Rapid movements and a movement change of the thread guide according to the invention are favored.

So that the thread can be fed to the thread guide at a high speed reliably and without undesirably high frictional forces, which could lead to damage or impairment of the thread, said thread guide preferably has a thread inlet with two roller pairs, which are arranged one behind the other in the main running direction of the thread or along a longitudinal axis of the thread guide. The rollers of a roller pair, in this case, each have rotational axes oriented parallel to one another, the rotational axes of one roller pair being oriented substantially orthogonally to the rotational axes of the other roller pair and it being possible, in each case, to guide the thread through between the rollers of the two roller pairs.

A further improved thread passage or reliable displacement of the thread can be achieved according to the invention in that the thread guide roller and/or the rollers of the thread inlet of the thread guide have a surface, i.e. lateral surface, oriented to the thread to be used, with only low adhesion. An adhesion of the thread, which is coated or impregnated with a sticky process material, for example to form the matrix described at the outset, on the rollers or the thread guide roller is thereby avoided. An undesired increase in the thread tension with the danger of a further detachment (breaking away) of the thread from the winding body can also thus be counteracted. The surface of the thread guide can consist, according to the invention, in particular of PTFE (polytetrafluoroethylene) or polyoxymethylene (POM), which have low static friction and sliding friction.

For the purpose of a defined transverse loadability of the traction means, the latter is preferably loaded with a predetermined tensile stress. This can be achieved by suitable tensioning means, in particular hydraulic elements, spring elements or else by deflection rollers or rods with an adjustable or displaceable rotary or body axis. Tension peaks of the traction means are preferably damped with suitable damping means.

So that the thread guide can also be guided against the winding body by a high pressing force, the thread guide is advantageously mounted so as to be additionally guided along the curved path. In this regard, a curved rail, in particular, may be provided according to the invention, on which the thread guide is additionally guided so as to be displaceable back and forth.

A particularly broad application spectrum of the thread displacement device is made possible in that the thread guide can be moved back and forth on a respective spatial plane between 7° and 348° relative to a starting orientation of the thread guide via a curved path. Complex three-dimensional components can thus also be produced in a fiber-reinforced composite mode of construction by the thread and fiber winding method.

At least one deflection roller of the traction means can preferably be driven by a motor. The traction means together with the thread guide can thus be moved back and forth in a structurally simple manner.

According to a development of the invention, the thread displacement device has a supply bobbin holder to rotatably hold a supply bobbin with the thread wound thereon. The supply bobbin holder is preferably provided with a drive and/or braking unit in order to avoid material damage such as on thin, break-sensitive threads, which may occur owing to excessive thread tension.

According to a preferred development of the invention, the thread displacement device has a thread tension monitoring mechanism with a thread tension sensor to detect a respective thread tension. As a result, a thread tension of the thread to be displaced on the winding body can be adjusted to a predetermined value or kept in a predetermined value range and fluctuations of the thread tension occurring during operation can be reliably compensated. In the deflection range of the thread guide, the thread tension can be minimized by the thread tension monitoring mechanism, i.e. the thread tension generally has a minimum at the deflection point of the thread guide. The thread tension monitoring mechanism is preferably coupled to a delivery device for drawing off the thread to be displaced from a thread supply bobbin or a control unit connected to the delivery device for open-loop/closed-loop control of the operating states of the delivery device or the aforementioned drive and braking unit of the supply bobbin holder.

A thread displacement system with a plurality of above-described thread displacement devices allows a simultaneous or delayed displacement of a plurality of threads on a winding body or a simultaneous displacement of a plurality of threads on different winding bodies. This can significantly accelerate a respective thread displacement process, which is advantageous, in particular, for industrial (mass) production. Moreover, defined thread or fiber layers, in particular ones which overlap one another, can be produced in a simplified manner. Different threads (type; material) can also be achieved on a winding body without laborious conversion of the thread displacement device or an interruption of the thread displacement process. Geometric ratios of a winding body to be produced can be recorded and the thread course can be adjusted or predetermined, even irregularly.

The invention will be described in more detail below with the aid of an embodiment shown in the drawings.

If the length of a thread during a winding process is kept virtually constant between a fan point and a winding point on a winding body, the compensation of the thread tension can be reduced to a minimum. Dynamic, rapid windings are possible in a configuration of this type of the device. The compensation of the thread tension is minimized and the dynamics of the thread guide are maximized.

The figures of the drawings show the subject of the invention highly schematically and are not to be understood to be to scale. The individual components of the subject according to the invention are shown in such a way that their structure can be shown well.

### BRIEF DESCRIPTION OF THE DRAWINGS

The accompanying drawings illustrate the invention. In such drawings:

FIG. 1a shows a thread guide according to the invention in a perspective detailed view;

FIG. 1b shows a thread guide according to the invention in an enlargement in section;

FIG. 2 shows a thread displacement device with a traction means and a thread guide fastened thereto according to FIG. 1, in a side view; and

FIG. 3 shows a schematic diagram of the thread displacement device from FIG. 2.

### DETAILED DESCRIPTION OF THE PREFERRED EMBODIMENTS

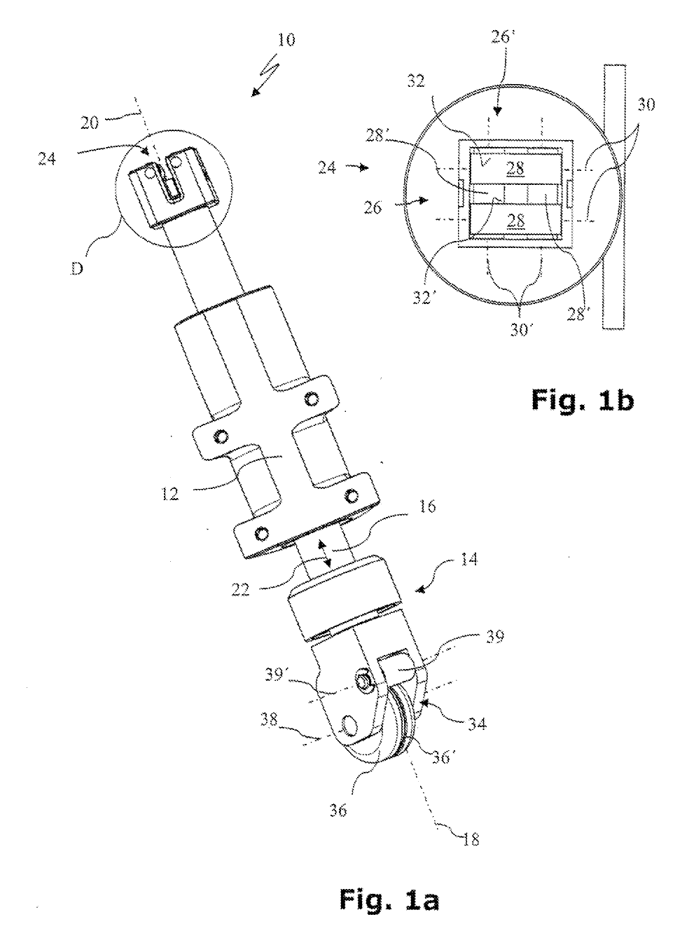

FIG. 1a shows a thread guide designated as a whole by 10, as used in a fiber-winding process for displacing a thread on a winding body. The thread guide 10 has a sleeve-shaped holding part 12, which serves to fasten the thread guide 10 on a traction means of a thread displacement device. A thread guide head 14 has a tubular bearing piece 16, which is hollow on the inside, extends through the holding part 12 and is encompassed thereby on all sides. The thread guide head 14 is rotatably mounted on the holding part 12 about a rotational axis 18 relative to the holding part 12 by the bearing piece 16. The rotational axis 18 of the thread guide head 14 in the present case coincides with a longitudinal axis 20 of the thread guide 10. The thread guide head 14 is held in its maximum extension position shown here relative to the holding part 12 by the force of a spring element not depicted in more detail and can be displaced along the longitudinal axis 20 in the direction of the arrow designated 22 relative to the holding part 12.

The thread guide head 14, at one end, has a thread inlet 24, by means of which the thread to be displaced on the winding body can be introduced into the thread guide 10, i.e. into the hollow bearing piece 16 of the thread guide head 14 here. The thread inlet 24, as emerges from section D of the thread guide 10 from FIG. 1a, which is depicted enlarged and in an end plan view in FIG. 1b, is provided with two roller pairs 26, 26′, which are arranged one behind the other and spaced apart from one another in the main running direction of the thread, i.e. in the direction of the longitudinal axis 20 of the thread guide 10 here. Rollers 28, 28′ of the roller pair 26, 26′ have roller rotational axes 30, 30′ oriented parallel to one another in each case, the roller rotational axes 30, 30′ being oriented orthogonally with respect to one another. The thread can in each case be guided through between the two rollers 28, 28′ of the individual roller pairs 26, 26′. The rollers 28, 28′, to contact the thread generally saturated or pre-impregnated (to form the matrix) with a sticky process material (for example a thermoplastic material), have a lateral surface 32, 32′ with only low adhesion, i.e. the adhesives used do not adhere to the rollers 28, 28′ or only insignificantly. The lateral surfaces 32, 32′ may, in particular, in this regard be made of PTFE (polytetrafluoroethylene) or another suitable material with a low static and sliding friction for the process materials used.

As furthermore emerges from FIG. 1a, the thread guide 10 has, at the other end, i.e. at its end opposing the thread inlet 24, a thread outlet 34, by means of which the thread can be guided out of the thread guide 10 or the thread guide head 14 here. Arranged in the region of the thread outlet 34 is an individual thread guide roller 36, which is configured as a self-directing roller and serves to guide and press the thread to be deposited on the winding body against the winding body. The thread guide roller 36 is freely rotatably mounted about a thread guide roller rotational axis 38 with respect to the thread guide head 14. The thread guide roller rotational axis 38 is arranged spaced apart from the rotational axis 18 of the thread guide head 14 and does not intersect it. During the thread displacement process, the thread is guided, at least in portions, about the thread guide roller 36 provided to contact the winding body and between the thread guide roller 36 and the winding body. A securing roller 39 serves to forcibly guide the thread guided out of the thread outlet 34 of the thread guide 10 in a peripheral guide groove 36′ of the thread guide roller 36. The securing roller has a securing roller rotational axis 39′ arranged in parallel to the thread guide roller rotational axis 38.

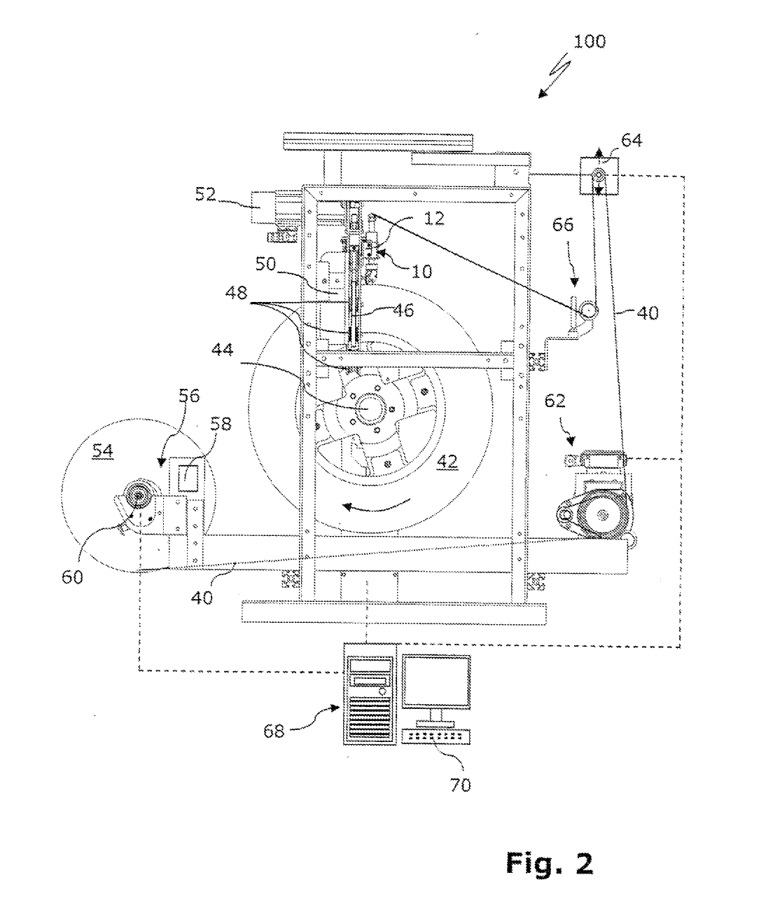

FIG. 2 shows a thread displacement device 100 with a thread guide 10, described above, for displacing the thread 40 on the winding body 42. The winding body 42 in the present case serves as the prototype to produce a so-called tire carcass, which is substantially formed from a multi-layer fabric of the thread. The winding body 42 is arranged so as to be rotatable by a motor about a rotational axis 44.

The thread displacement device 10 has a continuous traction means 46, which is only partially depicted here, which is manufactured from a steel weave. The traction means 46 is guided about deflection rollers 48 and guided past the winding body 42 in such a way that this traction means 46 substantially follows the outer contour of the winding body 42. The deflection rollers 48 are all arranged on a frame element 50 of the thread displacement device 100, one of the deflection rollers 48 being coupled to an electric motor 52, by means of which the deflection roller 48 can be driven at a variable speed and in a variable rotational direction, depending on the respective rotational movement or rotational position of the winding body 42 about the rotational axis 44 thereof. In total, the traction means 46 can be moved back and forth thereby in rapid sequence relative to the winding body 42 (traversing movement).

The thread guide 10 is fastened by its holding part 12 directly to the traction means 46, i.e. axially non-displaceably directly fixed thereon.

The thread displacement device 100 has a supply bobbin holder 56 to hold a supply bobbin 54 wound with the thread 40. The supply bobbin holder 56 is equipped with a combined drive and braking unit 58 to drive the supply bobbin 54 about a supply bobbin rotational axis 60 or to brake a rotating movement of the supply bobbin 54 about the supply bobbin rotational axis 60. A feed device 62 that can be actuated by a motor serves to draw off the thread 40, which is to be displaced on the winding body 42, from the supply bobbin 54, the thread 40 being guided from said supply bobbin by means of a thread tensioning monitoring unit 64 to a stationary arranged fan point 66 and from there to the thread guide 10.

A control unit 68 is used for the open-loop/closed-loop control firstly of the electric motor 52, which drives the traction means 46, secondly of the motor to rotationally drive the winding body 42 about the rotational axis 44 thereof, thirdly of the drive and braking unit 58 of the supply bobbin holder 56, fourthly of the feed device 62 and, in fifth place, is used to compensate for the thread tension. The control unit 68 is also coupled to the thread tension monitoring unit 64, so that the thread feed to the thread guide 10 can have a precise open-loop/closed-loop control depending on a predetermined thread tension.

A plurality of winding programs for different thread displacement patterns and different winding bodies are stored in the control unit 68 and can be retrieved and selected by an operating unit 70 connected to the control unit 68. Furthermore, the winding programs can also be freely modified or extended or replaced by further winding programs.

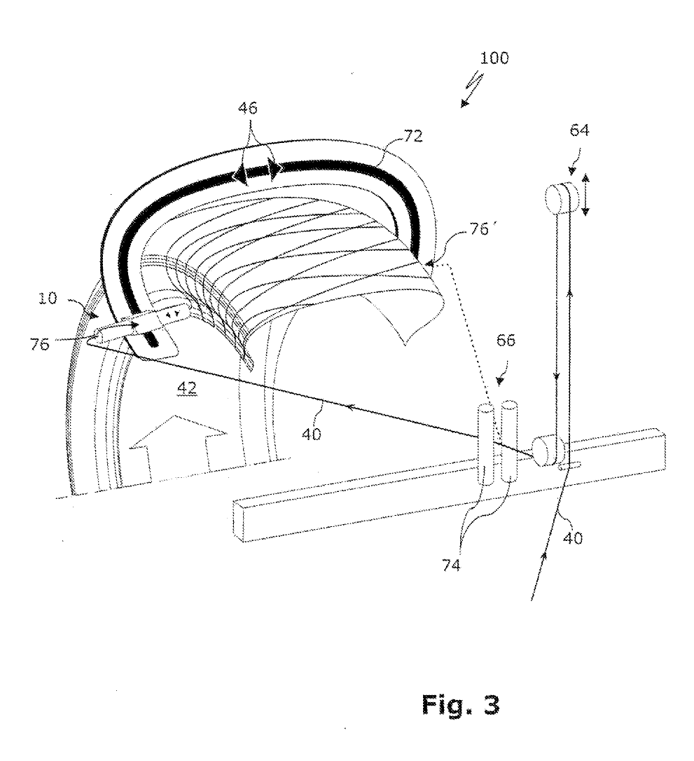

The thread displacement device 100 is depicted in FIG. 3 to illustrate the movement pattern of the thread guide 10 fixed on the traction means 46 during the thread displacement process, in a perspective part view. The traction means 46 are symbolized by arrows and show that the thread guide can be moved back and forth along a curved path 72. The figure shows well how the traction means 46 can move the thread guide 10 back and forth on the curved path 72 by means of a traversing movement of the traction means 46 relative to the winding body 42. The above-described fan point 66, from which the thread 40 can be (freely) fed to the thread guide 10, has two rigid guide rods 74 arranged spaced apart from one another and parallel to one another. The guide rods 74, according to a further embodiment, not shown, of the invention, can also be rotatably mounted along their longitudinal axes to minimize friction of the thread on the guide rods 74. The fan point 66 has the same spacing from mutually opposing end points 76, 76′ of the curved path 72, i.e. from movement direction reversal points of a movement of the thread guide 10 along the curved path 72. As a result, the active length of the thread 40 between the fan point 66 and the thread guide 10 is substantially (virtually) constant during the thread displacement process.

To displace the thread 40 on the winding body 42, a winding program matched to the winding body 42 for the desired winding of the thread 40 on the winding body 42 is firstly retrieved and selected by the operating unit 70 of the thread displacement device 100. The winding or thread displacement process is started after an approach to the start position of the thread guide 10 relative to the winding body 42 has been made. The thread guide 10 is moved back and forth by means of the traction means 46 driven by the electric motor 52 according to predetermined parameters (acceleration, speed, path distance) of the thread guide 10 and the winding body 42 moved synchronously therewith along the curved path 72. In this case, the thread 40 is displaced on the winding body 42 at a thread tension adjusted by the thread tension monitoring mechanism 64. The thread 40 is always guided before the thread guide roller 36 out of the thread outlet 34 of the thread guide 10 in the movement direction of the thread guide 10 relative to the winding body 42 and directed with guidance on the thread guide roller 36 in the direction of the winding body 42. The thread guide roller 36, in this case, always rolls down over the thread 40 on the winding body 42 and, in this case, presses the thread 40 at constant pressure on the winding body 42. The movement direction of the thread guide 10 relative to the winding body 42 changes abruptly in the region of the end points 76, 76′ of the curved path. Consequently, the thread guide roller 36 configured as a self-directing roller is automatically oriented along the new movement direction in the direction of the respectively opposing end point 76, 76′ of the curved path 72. A self-adhesive yarn (coated) can also be used as the thread 40 and/or the thread 40 is displaced on an adhesive sheathing (for example partly vulcanized rubber, unvulcanized rubber).

Controlled torque acting about the rotational axis 18 of the thread guide head 14 can, by way of assistance, additionally be exerted on said thread guide head. This torque can be applied according to the invention pneumatically, by the force of a pre-stressed spring element (not shown), or by a motor, not shown in more detail. The time coordination of the torque on reaching the reversal point may take place mechanically or else electronically, for example by means of the control unit 68.

The invention relates to a thread guide 10 for a thread displacement device 100 for displacing a thread 40 on a winding body 42. The thread guide 10 has a rotatably mounted thread guide roller for guiding and pressing the thread 40 against the winding body, the thread guide roller being configured as a self-directing roller. The invention furthermore relates to a thread displacement device 100 with a thread guide 10 of this type.

Although several embodiments have been described in detail for purposes of illustration, various modifications may be made to each without departing from the scope and spirit of the invention. Accordingly, the invention is not to be limited, except as by the appended claims.

What is claimed is:

1. A thread displacement device for displacing a thread on a winding body, the thread displacement device comprising:
a thread guide comprising a thread guide roller rotatably coupled about a thread guide roller rotational axis to a thread guide head, the thread guide roller configured as a self-directing roller to guide and press the thread against the winding body, and where the thread guide head is pivotably coupled about a rotational axis to a holding part of the thread guide, where the thread guide roller rotational axis of the thread guide roller is substantially perpendicular to and spaced apart from the rotational axis of the thread guide head, and where the thread guide head is displaceable in translation along the rotational axis in relation to the holding part of the thread guide; and
a guide means comprising a flexibly deformable traction means, the traction means defining a curved path, the curved path disposed along a respective spatial plane, where the thread guide is directly coupled to the traction means along the curved path and where the thread guide, which, depending on a movement of the winding body, can be freely selectively moved back and forth along the curved path defined by the flexibly deformable traction means by means of deflection rollers and/or deflection rods, the thread guide being able to move back and forth on the respective spatial plane along the curved path between 7° and 348° relative to a starting orientation of the thread guide.

2. The thread displacement device of claim 1, where the thread guide head is pneumatically loaded with a torque acting along its rotational axis in order to initiate a self-orientation of the thread guide in the region of the thread guide roller.

3. The thread displacement device of claim 1, wherein the thread guide comprises a thread inlet with two roller pairs arranged one behind the other along the rotational axis of the thread guide head, the rollers of each roller pair having roller rotational axes oriented parallel to one another and where the roller rotational axes of one roller pair being oriented orthogonally with respect to the roller rotational axes of the other roller pair for guiding the thread between the rollers of the two roller pairs.

4. The thread displacement device of claim 3, where the thread guide roller and/or the rollers of the thread inlet comprise an adhesion-free surface coating, and where the thread, which is coated/pre-impregnated with a process material, slides in an adhesion-free or in an insignificantly adhering manner when in contact with the adhesion-free surface coating.

5. The thread displacement device of claim 1, including a thread tension monitoring unit disposed ahead of the thread guide with respect to an incoming portion of the thread, where the thread tensioning monitoring unit is provided for open-loop and/or closed-loop control of a feeding of the thread to the thread guide.

6. The thread displacement device of claim 1, wherein the thread guide is mounted additionally guided along the curved path.

7. The thread displacement device of claim 1, wherein the thread is fed to the thread guide from a stationary arranged fan point, the fan point being spaced apart to an equal extent from respective end points of the curved path.

8. The thread displacement device of claim 7, wherein an active length of the thread is substantially constant during a winding process between the fan point and a winding point on the winding body.

9. The thread displacement device of claim 1, where the curved path's respective spatial plane is substantially parallel to the rotational axis of the thread guide head.

10. The thread displacement device of claim 1, where a rotational axis of the winding body is substantially perpendicular to the rotational axis of the thread guide head.

11. The thread displacement device of claim 1, where the curved path's respective spatial plane is substantially parallel to a rotational axis of the winding body.

12. The thread displacement device of claim 1, where the curved path's respective spatial plane is substantially parallel to the rotational axis of the thread guide head, and where a rotational axis of the winding body is substantially perpendicular to the rotational axis of the thread guide head, and where the curved path's respective spatial plane is substantially parallel to the rotational axis of the winding body.

13. The thread displacement device of claim 1, wherein the thread guide roller rotational axis of the thread guide roller does not intersect the rotational axis of the thread guide head.

14. A thread displacement device for displacing a thread on a tire during tire manufacturing, the thread displacement device comprising:
a thread guide comprising a thread guide roller, a thread guide head and a holding part of the thread guide head where the thread guide roller is configured as a self-directing roller to guide and press the thread against the tire, and where the thread guide roller is rotatably coupled about a thread guide roller rotational axis to the thread guide head, and where the thread guide head is pivotably coupled about a rotational axis to the holding part of the thread guide, where the thread guide roller rotational axis of the thread guide roller is substantially perpendicular to and spaced apart from the rotational axis of the thread guide head, and where the thread guide head is displaceable in translation along the rotational axis in relation to the holding part of the thread guide;
a traction means defining a curved path disposed along a respective spatial plane, the thread guide moveably and directly coupled to the traction means where the thread guide is controlled by deflection rollers and/or deflection rods allowing the thread guide to move back and forth about the respective spatial plane along the curved path between 7° and 348° relative to a starting orientation of the thread guide; and
a winding body rotatable about a winding body rotational axis, the tire attachable to the winding body;
wherein the curved path's respective spatial plane is substantially parallel to the rotational axis of the thread guide head;
wherein the winding body's rotational axis is substantially perpendicular to the rotational axis of the thread guide head; and
wherein the curved path's respective spatial plane is substantially parallel to the winding body's rotational axis.
